(19) United States
(12) Patent Application Publication
(10) Pub. No.: US 2025/0319404 A1
(43) Pub. Date: Oct. 16, 2025

(54) ADAPTIVE GAMING DEVICES AND METHODS EMPLOYING NEURAL AND PHYSIOLOGICAL SIGNAL DETECTION TO BIOMETRICALLY DETERMINE CHANGES IN PLAYER STATE AND ADAPTIVELY MODIFY GAME STATE BASED ON REAL TIME PLAYER

(71) Applicant: Michael Scott AMBINDER, Redmond, WA (US)

(72) Inventor: Michael Scott AMBINDER, Redmond, WA (US)

(21) Appl. No.: 19/173,771

(22) Filed: Apr. 8, 2025

Related U.S. Application Data
(60) Provisional application No. 63/633,651, filed on Apr. 12, 2024.

(51) Int. Cl. A63F 13/63; A63F 13/212

(52) U.S. Cl. CPC A63F 13/63; A63F 13/212

(57) ABSTRACT

The disclosure herein provides devices and methods for adaptive video gaming. In certain embodiments the invention includes systems and methods for detecting biological signals from a video game player to determine player state and adaptively modify game state based on detected player biological signals.

### TECHNICAL FIELD

The invention relates generally to devices and methods for adaptive video gaming. More specifically the invention relates to systems and methods for biological signal detection from a video game player to determine player state and adaptively modify game state based on detected player biological signals.

### BACKGROUND OF THE INVENTION

Video games are interactive electronic systems that employ a user interface (player input component) and a visual feedback component (video display). The display component can be a computer monitor, television, flat panel display, built-in game display, hand-held device (e.g., a tablet or smart phone) or virtual reality (VR) display. The user interface includes a multi-function “controller”, such as a hand-held controller, a joystick, keyboard, touchscreen, motion-sensing device, among other types of inputs, which can transmit a wide range of player directives, such as selection of game content, starting or stopping gameplay, selecting game difficulty level, commanding directional movement of a game subject or avatar, and determining in-game tasks (e.g., commanding movements or tasks of an avatar, selecting, reloading and firing of weapons, etc.)

There are many different hardware platforms for videogaming, including arcade video games, console games, computer (PC) games (including LAN games, online games and browser games), mobile platform games (e.g., played on smartphones or tablet computers), virtual and augmented reality games, cloud gaming, and even live interactive VR games (e.g., featuring advanced VR, with 3D motion capture and haptic body suits, where players interact physically within a live game arena). Videogames also encompass a wide array of subjects, styles and genera, with diverse target audiences, such as reality and fantasy role-play, first-person action, side-scrollers, platformers and others. Video games can range from simple content games played individually on a single device, to highly complex content games played by multiple players over a global network. Video games commonly also feature audio elements, which can include audio microphones to detect player voice inputs and allow interplayer conversation, and speakers, earphones or headsets to play audible game content to the player(s), along with optional use of webcams to enhance in-game chatting and livestreaming.

The video gaming industry continues to expand in terms of participating companies, user base and market strength, yielding annual global revenues of nearly $160 Billion US in 2020. Within the entertainment industry, the extraordinary growth and success of video gaming more than triples the market share of the global music industry, and outearns the global film industry by more than four-fold.

Future growth of the videogaming industry will depend in large measure upon improving user control features and operations. Most video games in use today still use conventional inputs (e.g., hand-held, touchscreen, mouse or keyboard controllers with manual control inputs). These traditional types of controllers have been improved over time to afford better user interactive experiences, for example incorporating joysticks, racing wheels, speed controls, trackballs, dancing pads, sport paddles, light guns, and the like, to better simulate different types of game play (e.g., for auto race or flight simulation games, conventional sports games, first person shooter games, etc.) Despite these improvements, there remains a need in the art for yet more sensitive and more widely operational controllers, to increase player immersion in the game environment and thereby improve player engagement and enjoyment in the gaming experience. Improved player engagement and enjoyment have been achieved in part through the advent of wireless controllers, including wireless controllers that feature IR and LED transmitters and sensors, accelerometers, and the like, to allow inputs mediated by player movements and even gestures in place of manual controller inputs (e.g., as in the case of VR headseats, haptic gloves, and even haptic suits for VR play, as used in various interactive fighting games, music play and dance games).

In the current game development world, various game development companies have further contemplated using passive “biofeedback” player inputs to enhance gameplay and improve gameplay experience. One contributor to this new field of game development is the company Valve Corp., of Bellevue Washington. In 2009, Valve Corp., led by principal inventor Michael Ambinder, filed a number of US patent applications entitled PLAYER BIOFEEDBACK FOR CONTROLLING A VIDEO GAME STATE. These patent applications, along with a later “continuation-in-part” patent application filed by Valve, matured into a family of closely related US patents (U.S. Pat. Nos. 9,511,289; 10,427,042; 10/981,054; and 11,253,781). Collectively these Valve patents describe a conceptual vision of how player “biofeedback” inputs might be used to alter game state (e.g., by changing game content, play state, level of game difficulty, etc., in response to player biofeedback inputs). However, while these disclosures suggest interesting concepts for biofeedback game control development, they are collectively deficient in practical teachings. Since the filing of these patents, nearly 15 years ago, Valve has not demonstrated practical implementation of any operable biofeedback game control device or gaming system (apart from using what are now conventional kinetic/VR game input controls).

Accordingly, there is a long unmet need in the videogaming industry for devices and methods to enhance player input operation and functionality, to enhance gameplay and improve gameplay experience. A related need exists for new tools and methods to integrate “biofeedback” player inputs into a videogaming system that can practically utilize these biofeedback inputs to adaptively alter game state in real time, and over extended or successive play sessions, to reliably enhance gameplay and improve gameplay enjoyment.

### SUMMARY OF EXEMPLARY EMBODIMENTS OF THE INVENTION

The invention achieves the foregoing objects and satisfies additional objects and advantages through the novel provision and use of biological signals, including physiological and neurological signals, as “game control inputs.” The biological signals are detected by a sensor array, which collects data for biometric analysis to determine or estimate one or more physiological, neurological, cognitive, mood or emotional states of a player. Biological signal detection within the invention is multi-focal and multi-modal, achieved by an array of neurological, physiological, anatomic, kinetic and other types of biological sensors designed to detect changes in player physiology, metabolic and/or cognitive state, neural and/or motor activity, and other biological changes that can be biometrically analyzed as reliable indicators to determine or estimate a selected player state or change therein. Data obtained from the biological signal detector array is processed to determine or estimate values for one or more identified player states, which when determined to correspond to an operative target state, directs an “input” to prompt a change in game state (e.g., a change in game elements, game environment, game characters, play sequence, game difficulty, etc.)

Among the biological signal detection and game input means that are useful within the invention are neurological signal detection/input devices generally known as Brain-Computer Interface (BCI) devices, which directly detect neural signals originating in the player's brain. A variety of BCI technologies are known in the art, including invasive (implanted) and non-invasive devices. Typically, BCI detection devices employed within the invention are non-invasive, for example head-mounted or inner ear electroencephalography (EEG) devices. These and other BCI systems are employed within the invention for neurological signal measurement to reliably determine or estimate selected player cognitive, mood and/or emotional states. The gathered signal data are biometrically processed to determine whether a control input will be made to adaptively alter game state (responsive to the detected value or change in player state).

Notwithstanding prior conceptualization and theory, all current video games are constrained by inputs that are mediated through conventional input devices (e.g., a hand-held controller, mouse and keyboard, gamepad, VR controller, etc.) These afford no adaptive functionality reflexive to the player's cognitive, mood or emotional experience while playing the game. The invention herein provides tools and methods for detecting values or changes in a player's internal state, including cognition, mood, physiological and emotional responses to gameplay, allowing for positive alteration of game state to adaptively and constructively respond to changes in player state, both in real-time and over the course of successive play sessions.

The following detailed description is provided to illustrate fundamental designs, means, operations and principles of the invention, through illustration and explanation of exemplary embodiments. No limitation of the invention is intended by this description, and persons of ordinary skill in the art will appreciate that alterations, modifications, substitutions, refinements and further applications of the objects, materials and principles described herein fall within the inventive scope of this disclosure and the appended claims.

### DETAILED DESCRIPTION OF EXEMPLARY EMBODIMENTS OF THE INVENTION

The disclosure herein provides novel gameplay systems and methods that constructively adapt game state to a wide range of detectable values and changes in player internal state, for example corresponding to baseline, depressed or elevated states of player stress, emotional comfort, physiological arousal, and/or various states of cognition or cognitive deficit. In more refined applications, biometric detection tools and methods within the invention can determine or estimate more discrete player states, such as baseline versus elevated levels of player frustration, performance success, happiness, sadness, challenge, boredom and other identified player emotional, physiological and/or cognitive. In related embodiments, the biometric detection tools and methods of the invention can determine when a player has learned a new game element (e.g., an effective game object, shortcut or solution), recognized a previously encountered game element, or failed to recall a previously encountered game element. Similarly, the biometric detection tools and methods herein can function to determine, track, and in higher order operations to model a player's preferences and changing skill levels, as well as to identify, track and model player's positive and negative responses to specific game states. In yet more sensitive embodiments, discrete player reactions can be determined or estimated, such as novelty, surprise, anger, jubilation, neutrality, flow state, decision making, attending an object in space, engagement, immersion, mind-wandering, problem-solving, playfulness, exploration, physiological arousal, anxiety, fear, disgust, competency, irritation, doubt, uncertainty, focus, distraction, hope, despair, fatigue (including physical and mental fatigue), desire to end a session or continue playing the game, addictive impulses, compulsive impulses, satisfaction, and many more target player state values or changes, which values or changes can be detected and processed to provide novel game “inputs” to direct adaptive game state changes in response thereto.

Useful player “biological signals” for detection and analysis within the invention include a wide range of neurological (including peripheral and central nerve, along with brain and neuroendocrine activity), physiological, and biokinetic, including eye, muscle and anatomic movement) are detected using a variety of non-invasive sensors and biological signal sources, including but not limited to, EEG, functional near-infrared spectroscopy (fNIRS), magnetoencephalography (MEG), functional magnetic resonance imaging (fMRI, detecting small changes in blood flow corresponding to changes in brain activity), heart-rate, blood pressure, blood gas and chemistry, galvanic skin response (GSR), body-temperature, eye-tracking, electromyography (EMG), and other detection systems and targets to map values or changes in facial expressions, muscle tension, vocal qualities, pupil dilation, among other useful sensors and signal sources. For increased sensitivity and reliability of signal detection and analysis, triangulation methodologies are beneficially employed in the data processing. Triangulation refers to various processes using inputs/data streams from multiple data sources (e.g., from different physiological sensor types, or from multiple sensors of the same type gathering distinct data, for example multiple EMG sensors detecting myotension at multiple facial muscle targets) to increase the efficacy and accuracy of player state determinations. One illustrative example of triangulation is comparing measurements of player physiological signals indicative of arousal, with contemporary measurements of facial muscle activation around the eyes and mouth indicating a smile, which may be further triangulated with contemporary data input regarding game state, for example indicating a contemporary game state demonstrating that a reward had just been granted in-game, whereby a triangulation-validated determination of player state indicates the player experienced enjoyment/happiness at the subject time in response to the correlated game state. Whereas a single type, frequency or value of a discrete player biological signal will at times provide sufficient information to reliably determine a player state, including any targeted cognitive, physiological or emotional state, using multiple data streams helps to discriminate and valuate or weight each component signal source, increasing accuracy and reliability of player state determination. In other advanced operations signal data previously collected and stored from the same player, a different player, or an index pool of players, is stored and used for comparative reference in data processing and machine learning as described, to even better interpret real time player signal data.

Utilizing biological signal data collected from a player in real time, a wide range of biometric values can be determined, some of which will be processed to generate a responsive game input (e.g., if they differ from a pre-determined baseline, target or threshold value, or if they correspond to, fall below, or exceed a set reference value) to direct the game to adapt in a variety of ways. Video games typically have internal dynamism, but they are often static with respect to the user's experience. For example, conventional video games adapt to direct player commands through manual inputs to move the player directionally, reload a weapon, choose a dialogue option, navigate an obstacle, attack a selected enemy, etc., but no existing games provide for adaptive game function in response to a player's subjective experience or internal state. In contrast, the instant invention provides for a much richer and rewarding gaming experience, by adaptively varying game elements, characters, play difficulty and other features in response to dynamic measurements of the player's internal state (in real time, as well as historically based on reference values recorded for an individual player, and optionally in comparison to reference values gathered from other players).

In certain illustrative embodiments of the invention, biological signals are detected from a gaming player to determine or estimate a level of anxiety, stress and/or arousal. A sensor array detects one or more physiological and/or neurological correlates of anxiety, stress and/or arousal, and these biometric data are analyzed by the system processor (and optionally stored into system memory) to determine if a positive state (e.g., elevated anxiety over a pre-determined, memory-stored player baseline value, or compared to a pre-determined control or reference baseline value) has been detected, for example as indicated by one or more of the following biometric results: increased heart rate; elevated blood pressure; increased respiration (typically more frequent, shallower breathing); increased muscle tension; increased blood flow (including peripheral blood flow, and blood flow to the brain); and/or increased perspiration, among other indicators of anxiety (see, e.g., Hoehn-Saric et al., J. Affect. Disord, Vol. 61 (3), 2000, pp 217-224). The biometric results determined by the processor are further interpreted to implement “smart” or “adaptive” biometric input operations to alter the game state in real-time to accommodate, adapt to, challenge, or attempt to operatively alleviate, exacerbate or redirect the player's determined state.

Anxiety is a particularly valuable target for biometric analysis of player state to direct adaptive game state changes within the invention, as are the closely related neurophysiological player states of stress and arousal. Anxiety can be conceptualized as a biological warning/response system that prepares the body to react mentally and physically to challenging and potentially dangerous situations. To respond to threatening stimuli, the human body prepares itself for “fight or flight”. In normal cases of anxiety, the individual responds adaptively by exhibiting, generally neurophysiological “hyperarousal.” This includes increasing the body's muscle tension, heart rate, blood pressure, sweat gland activity, and respiration. Subjectively, the individual feels excited, tense and flushed, and exhibits elevated sensory capacity and accelerated and strengthened motor responses. These heightened physical, neural and physiological responses are mediated by a neuroendocrine reaction involving increased blood levels of epinephrine and norepinephrine, cortisol, growth hormone and prolactin.

Anxiety and arousal levels contemplated as useful player state “inputs” for directing adaptive gaming operations within the invention will typically fall within the range of “normal anxiety”, as compared to pathological anxiety states. Pathological anxiety conditions include generalized anxiety disorder (GAD) (Hoehn-Saric et al., 1989), panic disorder (PD) (Hoehn-Saric et al., 1991) and obsessive-compulsive disorder (OCD) (Hoehn-Saric et al., 1995), all of which are chronic conditions that depart substantially from normal “anxiety”. Individuals with these pathological anxiety conditions exhibit atypical anxiety responses to normal stress stimuli. They do not show generalized baseline hyperarousal, however they do exhibit increased baseline muscle tension. During exposure to laboratory stressors, such as a divided-attention task, or risk-taking task (for example in which subjects can win or lose money), forehead muscle tension changed little in GAD and PD patients, but this value changed markedly in nonanxious controls (Howehn-Saric et al., 1989, Hoehn-Saric et al., 1991, Hoehn-Saric et al., 1995). Nonanxious individuals having normal baseline forehead muscle tension responded much more detectably to laboratory stress stimuli, with significantly larger increases in muscle activity, allowing attribution of the biometric change as a task-oriented response rather than a generalized stress response. Other biological indicators of anxiety would likewise be more difficult to detect and operably quantify in chronic anxiety patients for adaptive gaming operations within the invention. While heart interbeat interval, blood pressure, skin conductance and respiration of chronic anxiety patients do not generally exceed those of normal controls at rest, individuals with PD, GAD and OCD showed significantly weaker responses to laboratory stress stimuli in all of these neurophysiological indicators compared to control subjects, indicating that patients with anxiety disorders actually have a diminished range of arousal responsivity to stress stimuli. The studies correlate well with other reports (see, e.g. Hazlett et al., 1994; Lader and Wing (1964)) reporting that chronic anxiety patients exhibit weaker galvanic skin responses to auditory stress stimuli than normal subjects, and habituate slower to the stress stimulus. Chronic anxiety patients also show smaller forearm blood flow increases under mental stress than normal subjects (Kelly, 1980).

In contrast to pathological anxiety conditions, normal anxiety is a highly adaptive and useful biological response state, which has broad implications for useful exploitation within the gaming methods and systems of the invention. Normal anxiety is adaptive and immediately beneficial, by directing the individual's focus and attention toward stressful stimuli, prompting specific coping behaviors, and stimulating potent neurophysiological arousal responses. These responses are readily detected and analyzed from a finite set of biological signals, allowing determination of highly useful target changes in “player state” for directing adaptive changes in game state. In practical terms, a spectrum of player states can be operationally defined, for example ranging from moderate arousal to substantial stress, to moderate or severe anxiety, and these states can be detected for an individual game player in real time. For both game development and adaptive gameplay, determination of stress/anxiety states in a player can be used as a guide, or as an active game input, to positively alter a game state (for example to introduce or substitute a responsive game environment, game element or character, or to increase or decrease game difficulty, etc.) Moderate stress induced by a game state will generally heighten the player's arousal, immersion, performance and ultimately the level of satisfaction within a play session. Accordingly, in certain embodiments detection of moderate stress will generally direct “input” of a command to change the game state by repeating or extending the “triggering” game state (for example, an environment or enemy that appeared in the game concurrent with the detected player stress response), which operation can be limited to real time play, or stored in system memory as a default input (i.e., to introduce the triggering game state without requiring detection of a new player stress response).

System operation at the other end of the stress/anxiety spectrum can be programmed alternatively, for example to eliminate or reduce an undesirable triggering game state during a play session, or across future play sessions, to lessen or prevent unpleasant or disturbing gameplay. Severe stress and anxiety are known to cause cognitive disorganization and can severely impair neurophysiological response capacity (Hoehn-Saric and McLeod, 1990). In general applications, biologically responsive gaming systems of the invention will operate to reduce or lessen game states identified as severe stress/anxiety triggers for an individual player during a play session. If the same adverse trigger/response occurs multiple times, including across multiple play sessions, the game state (e.g., environment, element, character or level of difficulty) can be further modified permanently, for example by being reduced in incidence or degree, or eliminated entirely (likewise in game development, adverse biological response triggers widely detected across a reference pool of players can be reduced or eliminated).

In certain embodiments, extreme high stress triggers may be regarded by some gamers as a desirable challenge, whereby the player display can be programmed to display all proposed game state modifications, optionally with an explanation of the reason for the proposed change (for example by displaying “high stress trigger”), and the player can opt to veto or accept the recommended change(s). In applications involving interactive gaming embodiments, the system programming provides for players to participate in “open player state” gameplay, wherein each player can monitor (and archive with notations) biological signal data from other players. In these applications, for example, one player is able to observe high stress triggering game states displayed for other players and can electively re-play this game state as a disabling stratagem against that player. Likewise for positive trigger elements observed in interactive open player state gaming, a teammate or sympathetic player can identify and re-play game states observed to trigger a positive response (e.g., a positive emotional reaction after a successful play event) in another player.

Exemplary sensor arrays for use within related embodiments of the invention, i.e., for determining player arousal, stress or anxiety levels or changes, can feature any combination of sensors for detecting levels and changes in a plurality of biometric indicators correlated with stress, anxiety and arousal.

In certain embodiments, the sensor array includes monitor(s) for detecting one or both biological stress indices of elevated heart rate, and elevated blood pressure. A very extensive selection of combined heart rate and blood pressure sensors are commercially available, for example as compact wrist-worn, multi-function sensor arrays, finger-applied heart rate and blood pressure sensors, touch pad combined sensors, and a variety of other useful multi-sensor devices.

Useful stress/anxiety sensors for use within the invention may also include means for 00023 detecting respiratory levels and changes, exemplified by a host of commercially respiratory rate monitors utilizing inductance, plethysmography, capnography, bioimpedance and/or piezoelectric sensors.

Additional stress/anxiety sensors for use within the invention may include any of a variety of sensors that detect stress-related myotension. These sensors can be applied at different sites, including as wearable sensors positioned against the player's forearm or forehead. In one illustrative embodiment, a myotension monitor such as an EMG device is integrated with other sensors in a headband or cap-mounted, multifunctional sensor array.

The stress/anxiety sensor array may further include means for detecting changes in peripheral blood flow, which sensors are also available in a range of types and technologies (e.g., employing photoplethysmography, thermal analysis, and/or Doppler ultrasound). An exemplary blood flow sensor that is easily integrated within a wearable sensor array is a photoplethysmography blood flow sensor, which detects levels and changes in blood flow optically, typically in juxtaposition to the fingers, earlobes or facial skin of the subject. In related embodiments, the sensor array may include means for detecting levels and changes in blood flow to the brain.

In related embodiments, the sensor array incorporates means for detecting a level or change in cerebral blood flow (CBF). CBF data have been correlated with a range of discrete brain activities, many of which are useful objects for biometric monitoring and modeling within the invention. These data can be collected and processed, for example, to determine useful biometric indicators of stress, excitement, cognitive stimulation or malaise, and various mood and emotional states, all useful data to direct novel “inputs” to direct adaptive game state changes within the methods, operations, applications and systems of the invention. There are many sensor devices and methods for measuring CBF, though most are very costly, cumbersome and require a physician or expert technician to operate. One feasible sensor methodology for use within the invention is fMRI. More useful still is the relatively new technology of functional interferometric diffusing wave spectroscopy (fiDWS). This technology introduces and collects near-infrared light via the scalp, employing inexpensive detector arrays to rapidly monitor light fluctuations that encode brain blood flow index (BFI) (a direct correlate of CBF). Compared to other functional CBF monitoring approaches, fiDWS measures BFI faster and deeper, while also providing continuous signals. Optical BFI measurements using fiDWS reliably show a graded hypercapnic response, consistent with human cerebrovascular physiology, and provide a better contrast-to-noise ratio than other technologies during brain activation (see, e.g., Zhou et al., Science Advances, Vol 7(20), 2001). CBF data detected from players during game play sessions can be processed and correlated with a wide range of selected player states described herein (e.g., excitement, happiness, success, challenge, boredom) to determine “inputs” that alter game state responsively, in real time (and optionally extended to successive play sessions).

In related embodiments, the sensor array incorporates means for detecting a level or change in player perspiration associated with stress or anxiety. These sensors reliably detect levels and changes in galvanic skin response (GSR). GSR sensors are inexpensive and available in a variety of body-worn, applied or touch pad device formats.

Also useful within the invention for detecting biological signals associated with stress and anxiety are photometric devices for measuring changes in player facial expression and coloration. These sensors can detect facial expressions and coloration changes (e.g., flushing) associated with stress and anxiety (and in other aspects of the invention, with general arousal, or intense emotional responses). Facial scanning systems capable of mapping facial expression and coloration changes are widely used in law enforcement and security applications, and these technologies can be readily integrated into the systems herein, including by employing a player's webcam for photometric data collection, and commercially available software to analyze photometric data to detect stress or arousal-related facial expression and flushing patterns.

Exemplary facial expression analytic tools for detecting target player states (such as stress, frustration, surprise, confusion, happiness, etc.), will also benefit by employing multiple sensors and/or sensor types, with multi-source data coordinately analyzed for accuracy and reliability validation as described above. For example, a sweet of sensors and software commercially available from iMotions, Inc. (Copenhagen, Denmark) detects concurrent physiological and anatomical signals, including webcam-based eye tracking data, EDA/GSR, EEG and ECT data, along with facial expression analysis (FEA) data, to monitor and model human physiology and emotion. These and other commercially available multi-sensor arrays and software packages are readily integrated into the systems, applications and methods of the invention.

Similarly, Affectiva provides another commercially available multi-sensor system and software package useful for determining human cognitive and emotional states, which combines FEA with voice mapping, or vocal expression analysis. Whereas vocalization is not commonly involved in direct player game inputs, some gaming systems do involve vocal command inputs, and vocalization is significantly involved in live-streaming game play. Vocal expressions are a rich source of cognitive/emotional/physiological data for evaluating player state, and VEA sensors and software will be usefully integrated into various systems, applications and methods of the invention.

Sensors and data processing tools for tracking player eye movement is a particularly useful component of many embodiments of Applicant's invention. For example, eye movement tracking (optionally coupled with means for detecting and analyzing eye blinking, eyelid drooping, and/or pupil dilation) is useful for detecting and analyzing player stress, confusion, flow state, cognitive focus or lack of focus, physiological or mental exhaustion, disinterest, debilitating negative emotions and many other discrete player states within the invention. One exemplary eye tracking sensor type is a photometric sensor, easily and affordably integrated through a player's PC or web camera. Eye tracking software is widely available and compatible with all relevant platforms. In one general embodiment, eye movements track player attention, indicating whether a player is watching their screen, and optionally when the player is attending a particular object in the screen space. Eye tracking data can thereby be analyzed to map and model a player's focus, attention, and even proficiency over a play period. Other aspects of eye movement can indicate negative player states. For example, player gaze fixation can reveal stress, confusion, distraction, or disinterest. Rapid eye movements between objects or fixation points (saccades) are normal and adaptive, enabling rapid scanning of a visual field to identify objects of interest (also for rapid scanning of text), but if saccades continue without object selection, particularly in gaming, these data may indicate stress, indecision, lack of knowledge, or disinterest.

In one embodiment of the invention using eye tracking data sampling and analysis for adaptive gaming, excessive eye fixation or saccades can be identified as a target player state, to trigger certain adaptive game state changes (regardless of whether the eye movement pattern is associated with stress, confusion, exhaustion, or another more specific cognitive, emotional or physiological state). Game state changes that are potentially adaptive to a player state marked simply by eye fixation, or prolonged saccades without object selection, include resolution aids or hints, such as slowing game pace, slowing character and object movements, changing object or character location or identity, highlighting or altering contrast or colors of characters or objects, introducing a new, dominant object to divert player gaze fixation, altering tempo or volume of a game soundtrack, among many other game state changes described herein. In cases where gaze fixation is particularly prolonged, or when other biometric data point to disabling player emotional state or confusion, the adaptive game state change may be to visually or audibly provide a responsive prompt or tutorial that guides the player to a correct game object, process, path to progression, or any other solution.

In general, biometric analyses performed by Applicant's novel biological signal collection and biometric data analysis systems for enhancing video gameplay are based on combined data sets when available (i.e., data from multiple sensors, detecting different types of biological signals), and are weighted in the analytic or processing stage to provide more reliable determinations or estimations of player state. This weighting operation can be achieved, for example, by storing reference data obtained from the player, and/or from test subjects, in system memory, against which the processor compares real time player data, to better discern whether an estimated player state is reliable (for example if the real time player data conform to or exceed an established player baseline, mean or peak value, or a pre-determined reference value). In one illustration of this functionality, a panel of test subjects is “mapped” through one or more arousal-, stress-, or anxiolytic-response exercises, to determine consensus arousal, stress and anxiety responses. Standard protocols for eliciting and recording arousal, stress and anxiety responses are employed, which may include any of a variety of textual, videographic, and even field exposure stimulus-response surveys. These can follow a conventional format (e.g., an American Psychological Association (APA) approved psychological arousal, stress or anxiety test/survey), or employ a format that is more aligned with videogaming, for example employing videographic stimuli-based tests. The broad scope and sweeping utility of reference data that can be generated using these methods greatly expands the functionality and sensitivity of player state adaptive gaming within the invention. For example, reference data can be routinely generated, collected and stored in system memory to define discrete response states that correlate discretely with arousal, versus cognitive stress, versus mild or severe anxiety. These “consensus” response values can be programmed or imported into system memory as baseline or threshold reference values, and if real time player data meets or exceeds these baseline or threshold values, this result can be designated to prompt a game “input” directing a specific game state change.

Refining these operations even further, certain embodiments of the invention provide for confirmation or alignment of player state estimations against reference or index values stored in memory (which may be derived from the player herself, from other active players participating in an open player state network, or from an index pool of test players). In one illustrative embodiment, a player encountering an arousing, high stress, or anxiety-inducing game state may exhibit multiple biological signal changes (e.g., elevated heart rate, increased CBI, facial flushing) corresponding to elevated arousal, or stress. The system will generate a preliminary biometric determination, for example indicating either arousal or stress (based on a “best data set” determined to most reliably predict a particular player state from among active data sources, e.g., pulse, blood pressure, respiration, myotension, blood flow, perspiration, and/or facial expression/flushing sensors), and this determination will be displayed on the player's screen. The player is then prompted to confirm or deny the player state determined by the system, select a different interpretation (e.g., select “arousal” in place of “stress”), or ignore the prompt as irrelevant to their preferred play. This player confirmation of predicted player state mode can be selected on, suspended, or turned off altogether by the player. In open player state gaming, player state estimations and player confirmation selections for each player are visible to all participants. Player confirmations of system-determined player state determinations are recorded in memory and increase a reliability index for the reference data set, and this weighting can be applied to closely matched data sets that appear during later play, thereby refining the functionality toward increased reliability and improved performance through machine learning or AI. Machine learning approaches are very effective at extracting pattern (or structured signal) from noisy datasets, as will often be encountered with physiological measurements. There are a variety of ML/AI approaches, including but not limited to regressions, neural networks, decision trees, support vector machines and other tools useful to build predictive models that take complex data streams, such as physiological data streams, as inputs and discern patterns therefrom (for example to detect discrete cognitive, emotional and/or physiological player states, and generate novel gaming inputs therefrom). Other predictive modelling approaches may be utilized alternatively, or supplementally, to improve accuracy of analyses, for example classical signal processing techniques, Fourier Analysis, etc. Through these and related operations, biometric adaptive gameplay becomes more sensitive, discerning and responsive to player state changes over the course of a gaming session, and even more so over a course of many successive play sessions.

In other embodiments of the invention, biological signal detection and biometric analytic functions of Applicant's system and integrated software are competent to determine discrete player emotional and cognitive states, to generate novel insights into real time player experiences. These determinations can be refined in sensitivity and particularity based on standard psychological reference data collection, integrated into system memory and in-game processing, as described above, and can also be refined and revised based on individual player data gathered over time, with and without player confirmation input as described. According to these teachings, identified player cognitive and emotional states can be detected and analyzed, with improved reliability and discernment through machine learning over time, including such desired object states as novelty, surprise, anger, satisfaction, jubilation, neutrality, flow state, decision making, attending an object in space, engagement, immersion, mind-wandering, problem-solving, playfulness, risk-taking and risk aversion, exploration, physiological arousal, anxiety, fear, disgust, competency, insecurity, irritation, doubt, uncertainty, focus, distraction, hope, despair, mental and/or physical fatigue, desire to end a play session or continue playing the game, addictive habituation, compulsive impulses, and many more target player state values or changes. All these states can be estimated, and refined over time, through employment of suitable sensor arrays and system functions and operations as described herein, and each of these states can be productively employed as a biometric game “input” to adaptively modify game state in real time response to player state, to deliver novel, more engaging, more challenging and more enjoyable gameplay.

For purposes of illustration, the following discrete player states are described in further detail as exemplary targets of interest for player state monitoring and biometric analysis to direct adaptive gameplay.

Physiological arousal will often be elicited in response to in-game events, challenges, characters, and other features. Both the occurrence and degree of physiological arousal as a player state are detectable and biometrically calculable within the systems and methods of the invention. Corresponding biometric determinations made by the system processor can serve to input a variety of commands to adaptively alter gameplay, as described. In related embodiments, arousal data accumulated for an individual player over time, or for groups of players to generate reference data, provide confirmatory data enabling increased reliability weighting (whereby, in recurrent instances the same or similar biometric readings for a player state can be programmed or selected to direct an adaptive game state not only to occur in one play session, but to be set as a default game state. These same operations and methods provide improved tools for designing and reconfiguring “adaptive” game features during game development.

Physiological stress, cognitive stress, and anxiety share certain common biological signal correlates (e.g., elevated heart rate, blood pressure, respiration, and perspiration, along with facial flushing), but as noted above these player states can each be readily distinguished using appropriate testing, data classification and reference data storage in system memory for access during processing. For example, physiological stress may be distinguished from different degrees of cognitive stress (e.g., poor decision making, profound confusion) and anxiety by reliable differences in skin galvanic response, peripheral blood flow versus CBI changes, respiratory rate differences, or even discrete facial expression responses (e.g., frowning or brow furrowing attending cognitive stress but not physiological stress). These distinctions are enabled through integration of reference data within the systems and operations of Applicant's invention, validated through approved medical and psychological testing methods, scales and surveys, and further confirmed through extended player use and operation of the system, applying machine learning as described.

Player frustration is another valuable player state that can be biometrically determined to operatively input adaptive game state changes within the invention. A frequently frustrated player is not likely to continue playing or return to a game, and such declines in usership can be contagious within an active play group, virally diminishing commercial success. Employing the systems and methods of the invention, frustration represents one of the more challenging player states to detect/map and quantify. Nonetheless, there are well established physiological, psychological and biometric correlates of frustration, and these can be detected and biometrically validated, even quantified, using the tools and methods described herein. In one illustrative study, relating to both learning and frustration, psychology researchers determined that readily detectable biological/biometric signals are directly correlated with positive learning reactions in human subjects, even in four-month-old infants. In one infant positive/negative learning study (where learning reward involves pulling a string to elicit an audiovisual stimulus, and frustration is induced by removal of the reward) researchers detected a high incidence of positive emotional facial expressions, increased operant arm movements, reduced heart rate, elevated respiratory sinus arrythmia (RSA) and other psycho-physiological signals as positive learning indicators during the reward phase. When frustration was triggered by extinction of the learning stimulus, the test subjects exhibited a suite of opposite psycho-physiological signals, including high rates of negative emotional expressions, reduced arm movements, increased heart rate, and suppressed RSA (Lewis et al., Infancy, 6(1), pp. 121-143, 2004). Many other studies are available detailing a wide range of biological signal-response correlates useful for signal detection and biometric determination of frustrated player states within the invention.

In the case of learning as a targeted player state for detection, analysis and quantification, a wide array of useful test instruments, models and surveys can likewise be employed to determine and scale player biological signal responses indicative of learning. These data can be readily collected from test subjects to map highly reliable sets of physiological data (e.g., pulse, blood pressure, respiration, peripheral blood flow versus CBI, eye tracking and pupillary physiologic signals, etc.), and non-physiological signals such as facial expression changes, postural changes, anatomical movements, etc. Validating these test data with well-designed surveys and scales is likewise routine, whereby reliable reference data can be routinely generated for storage and reference within Applicant's systems to process real time player biological signal data in reference to flexible and accurate index data, generating reliable estimates of player learning, even scaled estimates, for example ranging from individual task achievement, to broad task proficiency, to task mastery and overall game proficiency or mastery scoring. Naturally, these determinations will be further refined based on the player's actual game performance tracked and integrated into player state analytics as gameplay progresses, including over many sessions, and will be refined even further through player self-assessment and self-reporting (e.g., through operation of the “player confirmation of predicted player state mode”, described above).

Comparable to the high value and utility of frustration, and learning, as biometric targets of the invention, other key targets for adaptive gaming functionality include detecting and high-fidelity prediction of player emotional states. The invention provides for real time determination of a wide range of player emotional states. In one simple example, the invention determines whether a wide range of different game states appropriately elicit desired or intended emotions in players. Do players feel happiness when they are supposed to? Do they laugh or show amusement at intended humorous events or lines of dialog? Do they feel happiness when they encounter a favorite environment, game sequence, or ally, or when they complete a particularly challenging task? The systems and methods of the invention are sensitive and broadly applicable to resolve these and myriad other such inquiries, that will arise and be determined automatically, with increasing sensitivity and reliability, through continued play and operation using Applicant's technology.

As regards happiness generally, this is of course a broad player state definition, and one might initially view it as an elusive emotional state to identify and quantify biometrically. Indeed, the field of happiness physiology and neuroscience is exceptionally complex, ranging from conventional psychological and sociological investigation to hard-core neurochemistry and high-tech brain activity stimulus-response mapping studies. Fortunately for the purposes of practicing the invention, the hard science of happiness neurophysiology can be greatly simplified.

Happiness is regarded in the literature as arising from two different sources hedonia (pleasure) and eudaimonia (fulfillment, or achievement of purpose, meaning and satisfaction in life). Beyond pleasure and fulfillment of purpose/meaning, some psychologists have proposed a third component of happiness involving engagement, commitment, and participation in life (Seligman et al. 2005). Applying these definitions, scientists have made substantial progress in defining and measuring happiness, primarily using self-report instruments to measure subjective happiness and well-being, which can differ widely based on such factors as academic or career success, income, health or illness, and many social interactive factors (e.g., peer or family approval, abuse or trauma, grief, etc.) (see, e.g., Kahneman 1999). Research validates a clear distinction between pleasure versus meaning and engagement components of happiness. However, about the same percentage of people (around 80 percent) rate their overall eudaimonic (meaning/purpose) satisfaction as “pretty to very happy,” and their current hedonic mood or pleasure state as “positive” (positive being 6-7 on a 10 point valence scale, where 5 is “neutral”) (Kesebir and Diener 2008).

While these surveys provide meaningful indicators of mental well-being, their results are likely skewed by subjective bias. This bias, marked by a natural human tendency to over-report subjective pleasure and fulfillment, relates to self-reporting about the individual's life subjectively, but is much less likely to skew results when the self-reporting is about external objects, events, characters or circumstances (outside the individual's sphere of identity/control), which can be reliably reported with much greater objectivity and reliability. Underscoring this distinction, large fields of commercial psychology successfully focus on collecting reliable “happiness” data exclusively through self-reporting, for example surveys involving product reviews, city habitability ratings, or political polling. Using this same category of objective reporting (i.e., surveys on subjects that do not directly implicate player identity), test subjects such as game players are expected to yield highly sensitive and accurate data to identify and even quantitatively scale happiness and other emotional responses to such objects as game state elements (which is true for virtually the full array of game states described herein). Alternative game states (e.g., styles, themes, characters, rewards) that are regarded as emotionally material (i.e., that are intended, or observed, to elicit player emotional responses) can be routinely evaluated, and this information is operatively integrated in the systems, methods and operations of Applicant's invention to provide sensitive and dispositive “reference” or “index” data to weight or validate biometric predictions of player state. This weighting or validation can be applied to a real time biological signal-based biometric prediction of player happiness (see below) or can simply be used to forecast a presumptive player state based exclusively on reference data. In the latter context, if a character or other game state reliably elicits a happiness response among test subjects, the game can display a happiness tag (e.g., text, icon or emoji) concurrent with the appearance of this character, prompting the player to confirm or deny this response (e.g., in player confirmation of predicted player state mode). In the latter case, the system can build a model of player preferences through machine learning and apply this model, or aspects of it, to validate, modify or elaborate adaptive gameplay functions of the system during subsequent play.

More commonly, player emotion reference data that are gathered as above, are stored in memory and integrated through biometric data processing to validate real time biometric data collected from the player. Biological signals corresponding to “happiness” are well established scientifically and can be reliably detected and used as biometric data sources within the invention to predict and scale a wide range of player happiness states (e.g., ranging from satisfaction, to happiness, to joy, to ecstasy, which terms are assigned to different points or ranges along a quantitative scale of detected values). These biometric estimations, typically based on multiple signal source data, will be weighted/validated through operative use of detailed reference data gathering and processing, either from an individual player over time, or as pre-collected or later input reference data gathered from one or more test or index subjects, as described above.

In one application for detecting player happiness (also applicable to other positive, as well as negative emotional states), facial expressions (facial morphology, muscle responses and movements) are monitored and measured and/or quantified using available analytic software tools for facial expression mapping. One such useful tool is the Facial Emotion Recognition (FER) software package produced by Visage, Inc. (Linkopig, Sweden). This software is adaptable across many platforms and has been demonstrated to accurately map and track facial expressions of users (irrespective of age and gender) to reliably estimate a broad range of emotional responses for use within the invention. Visage Inc.'s FER package uses “Emotion AI” to detect facial expressions from images or videos, returning a probability distribution for each of six “universal” emotions, namely: happiness; sadness; anger; fear; surprise; and disgust, with a seventh biometric result designated as “neutral”. The quantitative operability of this and comparable facial emotion signal detection tools permits even more detailed estimates of emotions within the foregoing classifications, which fine scaling will be enhanced by the various weighting and validation operations of Applicant's technology, as described herein.

Additional signal detection methods and systems for determining player happiness states (as well as other positive, and negative, emotional states), will typically employ multiple additional sensors, as described above (for example pulse, temperature, peripheral and/or brain blood flow, eye movement, pupil dilation, haptic sensors, etc.), all of which tools and methods provide for better detection, classification and distinction of general and specific player states according to the teachings herein.

Negative player emotions, such as regret, displeasure, anger, disgust, futility and others, are equally important to identify and target with adaptive gameplay as are happiness and cognitive frustration. In general, when negative emotions are identified, the system will query whether these are expected or intended responses, which query will be resolved based on scientifically gathered reference data, or historical player data, as described. This internal validation operation, querying to compare actual player responses to predicted responses (i.e., expected responses based on game state and reference data), will typically be programmed as a default operation for preliminary evaluation of all monitored player states described herein. If a negative player state is intended (e.g., a reaction to a particularly hideous opponent, a particularly gruesome fight scene, or a particularly disastrous play sequence), or otherwise falls within acceptable parameters (e.g., is a typical or ordinary reaction on comparison to stored reference data, indicating a normal reaction to an intended, entertaining or stimulating play sequence), the corresponding input/command will typically be to store the conforming data for expanded reference in memory, with no change in game state prompted.

As in the case of detecting happiness and other positive player emotional states, negative emotional states can be readily detected and characterized in an acceptable level of detail and discernment using facial expression monitoring technologies. The FER package of Visage is just one example of a rapidly expanding armament of such tools and devices, proven to reliably distinguish, at a minimum, between happiness, sadness, anger, fear, surprise, disgust and neutral emotional markers, which can be detected and mapped as biological signals, and analyzed biometrically to yield reliable determinations of player state within Applicant's invention. Results obtained using these facial emotion signal detection tools are further clarified, validated and more finely scaled through the weighting and validation operations of Applicant's technology, as described.

Additional signal detection methods and systems for determining negative player emotional states will likewise be employed to supplement, validate and/or refine data acquired from facial mapping, again using multiple additional sensors. Useful sensors and biological signal targets for detecting negative emotional responses include, but are not limited to, heart rate, blood pressure, eye movement and other ocular-related signals (e.g., one or more of eye tracking, blinking rate and/or pupillary dilation), anatomical movement (e.g., using photometric or haptic sensors), muscle tension sensors (e.g., applied to forehead and/or forearm), respiration monitoring, and skin galvanic sensors.

When intense, inappropriate, or undesired negative emotional responses (for example anger, rage, disgust, futility) are detected, this will ordinarily represent an important determination for preferentially directing adaptive changes in game state. Intense anger or rage correlates with disruption of flow, loss of cognitive focus, error-prone decision-making, and an overall loss of proficiency. Adaptive changes in game state in this circumstance will ordinarily be selected as a preferred response/input, or even a default operation. Also in this circumstance, the player will ordinarily be alerted of the detected negative emotional state (which alert may also advise the player of related risks of errors, or diminished proficiency). In this case, as for all other player states described herein, particularly those that may indicate impaired or enhanced player performance, notifications of this kind shared with other players participating in “open player state” gameplay can provide teammates and opponents alike with strategic information, which in turn will elaborate and intensify the gaming experience for cooperating players. In these applications, the composition, activation state and operability of sensor arrays for each participating player will be visible to other open player state participants, and the thresholds and parameters for determining and displaying biometric player state results will be normalized across the player field.

Players may optionally dispute, deny or propose a modification to a determined player state, and in individual play the player can nullify any determined player state, along with the proposed or default game state modifications adaptive thereto.

Absent player nullification, a host of corrective or alleviating game state changes can be implemented in response to detection of a negative player state (as for all described player states). For example, the pace of the game may be slowed, the nature or capacity of an enemy or teammate can be responsively diminished or enhanced, the soundtrack can be adjusted to a lower volume, tempo, or more calming track of music, background lighting can be lowered or adjusted to a soothing color, in addition to innumerable other contemplated game state changes that will potentially soothe or eliminate the negative player state.

This general operation sequence of Applicant's invention (which works the same for all described player states) yields a growing data set from basic operation of Applicant's systems and methods, involving a flow of: game state stimulus-player state response-adaptive modification of game state stimulus-adjusted player state result. This operation flow provides for potent model building to determine and adjust optimal game state changes to best adapt to particular player states. This modeling operation is readily enabled within Applicant's systems to build higher order adaptive gameplay through machine learning, e.g., over a course of repeated game sessions for individual players, and is likewise useful for fundamental game design using player-approved access to reference play/operations data.

The system and methods of Applicant's invention are capable of tailoring each and every element and aspect of gameplay to an individual player's subjective experience, based on real time biological signal detection and biometric estimation of player emotional, physiological and/or cognitive states. This information is interpreted through the system's memory and processor to generate corresponding “inputs” operable to select corresponding, adaptive changes in game state. All game elements are subject to adaptive modification in this context, including game environment, theme, characters, play rate, play sequence, level of difficulty, etc.

Thus, in illustrative aspects of the invention, when a player's biological signal(s) detected by the sensor array correspond to, fall below, rise above, or depart significantly from, a selected biometric data threshold, statistical grouping, or other programmed biometric “target” or “trigger” value, or set of values, the system generates a corresponding “input” to direct a corresponding change in game state. For example, a biometric target data set corresponding to a “high stress” player state may include concurrent signal readings corresponding to elevated pulse, elevated blood pressure, and increased respiratory rate. Once the determination of high stress player state has been made, this generates a game state input that directs any one or more changes in game state selected as being adaptive to high player stress.

While the game state can continue to be controlled by the player through conventional inputs (e.g., hand-held controller, joystick, mouse and keyboard), the biometric inputs operate separately, at times supplementing or even overriding player inputs. In this regard, the biometric inputs are typically “passive”, meaning not intentionally controlled by the player (though they may be optionally overridden by player selection, or modified, e.g., through the “player confirmation of predicted player state” modality described above).

Exemplary alterations of game state contemplated for selection via biometric input control include: 1) Increasing or decreasing difficulty of game play responsive to player state (e.g., by increasing or decreasing a pace of game flow, increasing or decreasing a complexity of game content, increasing or decreasing capacities of enemies and/or teammates, increasing or decreasing number, difficulty or availability of objectives, tools, supplies, obstacles, time or failure limits, etc.); 2) Changing a game theme, environment, mood or other aesthetic game feature responsive to player state (e.g., modifying a setting, period, background, lighting, color, soundtrack or other aesthetic game feature responsive to player state; 3) Modifying game composition and/or flow, for example by changing player routes, landscapes, objectives, rewards, obstacles, weapons, opponents, supplies, tools, etc; and 4) Modifying game character composition, for example by re-casting a player's avatar to appear as a different character, or to exhibit changes that are “adaptive” to a detected change in player state (for example the player's avatar might change to display apathy or boredom if such is the detected player state, or instead might snap to attention and show eagerness, surprise, or displeasure to jog the player out of a bored or apathetic state). These are just illustrative examples of where and how game state can be modified adaptively responsive to player state. All other aspects of gameplay fall within this objective, spanning all videogame genera, formats, themes, styles and subjects. Likewise, the level of detail contemplated for desired game state modifications can range from very sweeping and general, to minute and highly specific.

One illustrative example of game state changes within the invention that focus more specifically are “adaptive enemies” and “adaptive teammates”. A host of determinable player states are regarded as rich subjects for generating adaptive enemies and teammates. For example, if a player state of happiness, satisfaction or arousal is detected in response to introduction of a specific teammate, this biometric determination can be programmed to generate an input commanding closer alignment of the player with that teammate (e.g., directing the player and teammate to be more aligned spatially, temporally, task-wise, goal-wise, and/or to share weapons, tactics, supplies, equipment or other resources within the game). In another operation, a positive or negative player state response to a particular teammate may be programmed to direct a change of appearance of that teammate's avatar, for example to be more or less illuminated, change color, or display altered or exaggerated features for improved recognition of that teammate by the player. When multiple players are networked in “open player state” gameplay, as described above, players can see and react to these biometric responses to each other's presence and performance within the game. Adaptive enemies are likewise rich objects for game state modifications responsive to real time player biometrics. According to the teachings herein, Applicant's systems and methods provide for ready determination of which enemies a player finds most enjoyable, challenging, arousing, stress-provoking, satisfying, irritating, boring etc., across the full range of cognitive, physiological and emotional responses detailed herein, all of which can be biometrically “mapped” or “fingerprinted” as being expressed by a player in response to particular opponents (and likewise for all other game features that induce detectable changes in player state). When a player's reaction is generally positive to a particular opponent, this biometric input can direct highlighting of that opponent's appearance as described above, or to increase the role, number or frequency of appearance of that opponent in subsequent play, and/or in successive play sessions. If the player's reaction to a particular enemy is negative (e.g., determined as provoking anger, high stress, boredom, or disruption of flow), that enemy's role can be reduced or eliminated, or its adverse capacity can be diminished or substituted by one the player exhibits greater facility against. For both teammates and enemies, all characters toward which the player shows a predominance of negative reactions can be minimized, eliminated, muted, or altered in appearance, conduct, aggressive capacity, etc.

Yet another example of more specific game state changes within the invention are adaptive weapons, and adaptive rewards. As for all game elements and features, weapons and rewards will elicit variable player responses manifesting as biological signals detectably by a competent sensor array. A sword versus a machine gun versus a grenade, for example, might elicit an excited, indifferent or anxious player state. A roll of bills versus a chest of gold versus a villa in Italy likewise will strike different players more or less positively, even perhaps negatively. Different levels of each cognitive response, physiological response, and emotion can readily be distinguished by scaling and reanalyzing cumulative player data over time, whereby even a qualitatively identical “happiness” or “aroused” or “eager” or “frustrated” or “stressed” or “angry” response can be discerned quantitatively as more or less intense for a known player monitored and calibrated over time (e.g., over many play sessions). In the exemplary case of weapons and rewards, positive or negative responses (or more positive or more negative responses for the same emotion), allow the system to make player preference distinctions, for example to serve as an input to reduce or eliminate a negatively encountered weapon or reward, or increase the capacity, or facility of attaining, a positively encountered weapon or reward. In other detailed examples, an adaptive weapon that elicits a high stress response in a player may be modified, for example by change a firing rate, enlarging a sighting field, dampening or facilitating weapon movement or action, altering reload parameters, and many other changes.

Yet additional player state targets for adaptive gameplay are identified and briefly discussed below.

Decision-making: The invention provides systems and methods for detecting and modeling player decision making, and for determining a resulting emotional state correlated with a decision-making event. In practical terms, this provides for adaptive gaming that promotes positive decision making (e.g., by increasing occurrence of game states that elicit the same or similar decision events as were determined to yield positive emotional responses by the player, and/or avoiding decision events determined to yield neutral or negative emotional responses.

In related embodiments, the invention provides effective tools for adaptive gameplay that employ biological signal detection for modeling players' unique preferences in gameplay, in relation to all aspects of game state, structure and design. For example, the invention allows for detection of what kinds of experiences players prefer (e.g., find more cognitively stimulating, or emotionally pleasing) based on determined patterns of cognitive, emotional and/or physiological signal detection, whereby game design, game elements, and all aspects of game state can be adaptively tailored (throughout a play session, or over an extended period of game use) to enhance player experience, challenge, satisfaction, enjoyment, etc.

Engagement: Eliciting high levels of player engagement is a key objective for all game developers. Engagement generally corresponds to a player's desire to continue play, both during a session and through a multi-session course of extended game use. The invention provides effective systems and methods to reliably detect and analyze cognitive, physiological and emotional player signals corresponding to strong engagement. Engagement is generally associated with a strong cognitive focus and correlated set of positive emotions that collectively prompt continued play. Player states that correlate with low or disrupted engagement include, for example, cognitive or physiological exhaustion, frustration, reduced challenges and/or learning events, apathy, boredom, etc. The adaptive gaming systems and methods of the invention use this information to modify game design, game mechanics and game state to either increase or decrease player engagement. Generally, the adaptive gaming operation (e.g., modifying game state to repeat engaging elements/characters/events) will be directed toward increasing player engagement. In other embodiments, such as to allow parental control to limit game play, or to deter addictive play patterns, the adaptive gaming operation will be directed toward decreasing or modifying player engagement.

Immersion: Immersion is another highly desired player state, related in part to flow and engagement, but operationally distinguishable within the systems and methods of the invention. Exemplary distinguishing metrics of immersion include imperviousness to distraction, low incidence of frustration, frequent learning/achievement events, elevated arousal, high proficiency, and flow, among others. The adaptive gaming systems and methods of the invention use information relating to player immersion state to modify game design, game mechanics and game state to either increase or decrease player immersion.

Concentration: Measuring player concentration is straightforward according to the teachings herein and is useful to direct inputs to yield adaptive gameplay as described, focusing on game state changes that increase or decrease player concentration.

Mental Workload: Adaptive gameplay operations within the invention will also be based on detection of player mental workload, related to stress, proficiency, concentration and other player state indicia. In some embodiments game state will be altered to increase or decrease a level of cognitive stress, or reduce attendant cognitive energy associated with a game operation, state or element. For example, if the player shows heavy cognitive strain relating to a particular environment, enemy or decision point, game state may be altered to alter the environment, introduce a new enemy or modify the decision point. Effort is generally related to mental workload, but is a distinct player state, often involving multiple player steps/inputs, and detectable through association with stress and loss of proficiency and/or flow.

The systems and methods of the invention further provide means for adaptive gameplay based on tracking and analyzing player cognitive, physiological and emotional signals associated with player performance, learning and achievement (which data are in-system correlated with in-game performance data, such as score, speed, proficiency, complexity, and other quantifiable results within the game). Player performance is detected based on a detectable set of cognitive, physiological and emotional signals, as described, whereby even very fine distinctions in player performance signals can be made (e.g. to allow distinction between conscious vs. unconscious competence or incompetence) to determine novel inputs that adaptively alter game state in relation to player performance state (e.g., to facilitate player performance, learning, task proficiency). Task proficiency, or skill mastery, is a distinct aspect of performance, which the invention provides for detection of in relation to player biological signals, interpreted in correlation with in game proficiency data. In one embodiment, the invention determines when a player has reached a high or top level of proficiency/skill mastery, and game state is altered to elevate skill/proficiency requirements, or adaptively direct the player to start using different skills.

Tutorials: For all target player states, the systems and methods of the invention will typically include tutorials responsive or adaptive to the detected player state, which tutorials may be a pop-up text or graphic, audible instructive message, or other mode/format lesson, aimed to address, remedy or instruct the player productively in response to the particular player state input.

Within additional embodiments of the invention, player biological signals can be detected and analyzed to determine that the player is losing enjoyment or interest in a game, or is otherwise likely to end a game session, or terminate use of the game altogether, whereby the game state is adaptively modified to promote renewed player interest, continued play, and/or long-term player retention.

Flow state: The system and methods of the invention additionally provide for detecting when a player is in a flow state and modifying game state to promote recurrence and/or maintenance of player flow state during a play session, or series of sessions. The term “flow state” was coined by Mihaly Csikszentmihalyi, a pioneer in the study of human happiness. Flow is an optimal state of consciousness and engagement that consistently yields satisfaction and happiness, from which the individual typically experiences feelings of strength, peak ability, high alertness, effortless control and unselfconsciousness. Illustrative examples of flow are a proficient skier effortlessly managing a high difficulty ski course, or a chess master engaged in a continuous course of challenging chess play. In relation to Applicant's adaptive gaming invention, player flow state is readily determinable biometrically. Flow is associated with rapid and efficient decision making, with a high level of proficiency and low error rate, without pause for conscious or deliberate consideration. Player flow state is determined through detection of any number of correlative biological signals, including eye tracking and EEG patterns. EEG patterns correlated with flow state include a combination of increased frontal theta and moderate frontocentral alpha rhythms (see, e.g., Kathahira et al., Front. Psychol, Vol 9, 2018). Eye tracking signals correlated with flow state include reduced, more accurate field scanning, faster object acquisition, reduced fixation, among other patterns. Flow state is also associated with more rapid, smoother and more accurate control selections and inputs (e.g., more accurate, direct and rapid mouse, joystick or arm movements), and improved hand-eye coordination (e.g., speed and accuracy of target recognition, acquisition and effective weapons deployment), among other indicia of flow. The invention provides for tracking and evaluation of player flow state (and precursors to player flow state), to enable adaptive gameplay that promotes sustained or increased flow when desired. In this context, game states that might diminish flow state (e.g., game states that are unusually confusing, arousing or distracting) may be reduced or eliminated. In related embodiments, when a player is determined to be in a flow state, the game may be adaptively altered to present the player with different classes of challenges or gameplay elements. In other embodiments, game state can be altered to induce or promote player flow state, for example by increasing predictive accuracy in the game (e.g., by limiting selections of weapons or objectives, or decreasing unpredictable outcomes), reducing distracting stimuli, such as flashing lights, dramatic color changes, fast looming objects, etc., and other flow-enhancing game state changes.

The systems and methods of the invention provide the foregoing tools and operations, along with a wide range of additional adaptive gameplay features and advantages. In general terms, the systems and methods of the invention allow detection, mapping and modeling of player intention. For example, if a player makes a choice in a game and immediately feels regret, for example (correlated with signals of stress or undue effort), even though this player state outcome would otherwise not be expected, the system can analyze this information, distinguish the player's subjective intention and adjust game state to adaptively construct a more positive experience.

The systems and methods of the invention also provide adaptive gameplay functionality in the form of “biofeedback loops”. When a player's experience yields biological signals that correspond to a particular mental state or feeling, for example frustration or happiness, the game can adaptively respond with game state changes that reduce negative player states and reinforce positive player states. This may involve interactive messaging or tutorials, for example to inform a player they are learning quickly, congratulate them for obtaining a reward, or advise on more specific player lessons to increase their proficiency and enjoyment.

The systems and methods of the invention are additionally operable to build models of player behavior from biometric and in-game data accumulated over time, refining the system's ability and accuracy to detect player state reactions to in-game features and events. These models can be player-specific, team of player-specific, class of player-specific, game-specific, component of game-specific, or even be used across games to build up platform level insight into player experience. This modeling function improves over time in part by reducing assumptions about player intent and preferences. Conventional games can't determine what a player likes or dislikes. This can only be inferred generally from in-game behavior, whereas Applicant's invention builds ever more accurate modeling data for mapping player characteristics and preferences, to tailor the gaming experience to desired features, or more closely match game state and objectives to a player's intent, through truly adaptive gaming. Through these data archiving and modeling functions, in addition to player state detection, Applicant's system and methods provide for detection of “precursors” to player cognitive and emotional state, which detected player state precursors allow for bypassing of some signal detection and data analysis, to serve as faster, more direct inputs to adaptively modify game state (and/or to predict, and induce or prevent, future player behaviors.

Although the foregoing invention has been described in detail by way of example, for purposes of clarity of understanding, it will be apparent to the skilled artisan that various changes and modifications can be practiced within the scope of the appended claims.

Various publications and other references have been cited with the foregoing disclosure for economy of description. Each of these references is incorporated herein by reference in its entirety for all purposes.

What is claimed:

1. A biofeedback adaptive video gaming system, comprising:
one or more biological signal sensors operable to detect one or more biological signals from a human game player;
a processor-readable storage medium; and
a processor operably coupled to the processor-readable storage medium and said one or more biological signal sensors, wherein during operation the processor:
provides game play to a video game player via a video game user interface;
receives from said one or more biological signal sensors biological signals from the player in real time during game play;
analyzes the received biological signals to determine a player cognitive, physiological and/or emotional state;
responsive to the analysis of the biological signals and determination of player state, inputs a game control action operable to effect a change in game state that is adaptive or responsive to the determined player state.
